(19) United States
(12) Patent Application Publication
(10) Pub. No.: US 2010/0293924 A1
(43) Pub. Date: Nov. 25, 2010

(54) CONTROL APPARATUS FOR INTERNAL COMBUSTION ENGINE, AND METHOD OF CONTROLLING INTERNAL COMBUSTION ENGINE

(75) Inventors: Kenji Harima, Shizuoka-ken (JP); Yasuyuki Irisawa, Shizuoka-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi, Aichi-ken (JP)

(21) Appl. No.: 12/864,151

(22) PCT Filed: Jan. 21, 2009
(86) PCT No.: PCT/IB09/00093

§ 371 Date: Jul. 22, 2010

(30) Foreign Application Priority Data
Jan. 23, 2008 (JP) 2008-012906

(51) Int. Cl. F01N 3/00; F01N 3/10; F02B 33/44

(52) U.S. Cl. 60/274; 60/300; 60/598

(57) ABSTRACT

A control for an internal combustion engine in which it is determined whether a request for a turbo flow mode is output and whether there is a possibility that a catalyst may be deactivated. More specifically, it is determined whether a catalyst gas temperature is above a predetermined value. The predetermined value is set in advance so that when the catalyst gas temperature is equal to or below the predetermined value, the catalyst is deactivated. When it is determined that there is a possibility that the catalyst may be deactivated if exhaust valves are placed in the turbo flow mode, a retard amount in an ignition timing retard correction is determined. An ignition timing is calculated. It is permitted to switch a valve opening mode to the turbo flow mode.

### FIELD OF THE INVENTION

The invention relates to a control apparatus for an internal combustion engine and a method of controlling an internal combustion engine. More specifically, the invention relates to a control apparatus for an internal combustion engine with a turbocharger, and a method of controlling an internal combustion engine with a turbocharger.

### BACKGROUND OF THE INVENTION

For example, Published Japanese Translation of PCT application No. 2002-520535 (JP-T-2002-520535) describes an apparatus (an engine with an independent exhaust system) that includes a first exhaust valve that opens/closes a first exhaust pipe connected to an exhaust turbine, and a second exhaust valve that opens/closes a second exhaust pipe that is not connected to the exhaust turbine. In the apparatus, when the engine is cold, the first exhaust valve is closed, and the second exhaust valve is opened so that exhaust gas flows bypassing the exhaust turbine. Therefore, it is possible to increase performance of warming up a catalyst. Also, after the warming-up of the catalyst is completed, the second exhaust valve is closed, and the first exhaust valve is opened to introduce the entire amount of the exhaust gas to the exhaust turbine. Thus, the engine produces a required output.

However, during an engine start (particularly, during a cold start), the exhaust turbine with a large heat capacity, and the first exhaust pipe in which the exhaust turbine is disposed are cold. Therefore, if the first exhaust valve is opened to satisfy the request for warming up the exhaust turbine, or the required engine output after the warming-up of the catalyst is completed, the temperature of the exhaust gas is sharply decreased when the exhaust gas passes through the first exhaust pipe. If the exhaust gas, whose temperature is decreased in the above-described manner, flows into the catalyst, the bed temperature of the catalyst may be sharply decreased, and therefore, the catalyst may be deactivated. As a result, the characteristics of exhaust emissions may deteriorate.

### DISCLOSURE OF THE INVENTION

The invention provides a control apparatus for an internal combustion engine and a method of controlling an internal combustion engine, which suppress deactivation of a catalyst, while satisfying a request for driving a turbocharger.

A first aspect of the invention relates to a control apparatus for an internal combustion engine, which includes: a plurality of cylinders each of which includes a first exhaust passage connected to a turbine of a turbocharger, a first exhaust valve that opens/closes the first exhaust passage, a second exhaust passage that leads to a position downstream of the turbine, and a second exhaust valve that opens/closes the second exhaust passage; a catalyst disposed in a third exhaust passage that is located downstream of a join point at which the first exhaust passages are joined to the second exhaust passages; catalyst-temperature correlation value determination means for determining a catalyst-temperature correlation value that is correlated with a temperature of the catalyst; turbocharger drive means for opening the first exhaust valves to drive the turbocharger; and ignition timing retard means for retarding an ignition timing, if the catalyst-temperature correlation value is below a first predetermined value when the turbocharger drive means opens the first exhaust valves.

A request for opening the first exhaust valves, which have been closed, to drive the turbocharger (hereinafter, referred to as “the request for the turbo flow mode”) may be output based on a required output of the internal combustion engine, or a request for warming up the turbocharger. In this case, exhaust gas flows in the first exhaust passage that has a large heat capacity. Therefore, the temperature of the exhaust gas is decreased before the exhaust gas reaches the catalyst, and thus, the catalyst may be deactivated. With the control apparatus according to the first aspect of the invention, if the catalyst-temperature correlation value is below the first predetermined value when the request for the turbo flow mode is output, the ignition timing of the internal combustion engine is retarded. When the ignition timing is retarded, the temperature of the exhaust gas is increased. Thus, according to the invention, it is possible to effectively suppress the deactivation of the catalyst, while satisfying the request for the turbo flow mode.

The ignition timing retard means may include retard amount calculation means for calculating a retard amount by which the ignition timing is retarded.

The retard amount calculation means may calculate the retard amount so that the retard amount increases as the catalyst-temperature correlation value decreases.

The retard amount, by which the ignition timing is retarded, is calculated to be increased, as the catalyst-temperature correlation value decreases. Therefore, it is possible to increase the temperature of the exhaust gas, as the temperature of the catalyst decreases. Thus, it is possible to effectively avoid the deactivation of the catalyst.

The control apparatus may further include first temperature determination means for determining a temperature of first exhaust gas that flows into the turbine. The retard amount calculation means may calculate the retard amount so that the retard amount increases as the temperature of the first exhaust gas decreases.

As the temperature of the first exhaust gas decreases, the temperature of the exhaust gas that flows into the catalyst decreases. Therefore, it is possible to effectively avoid the deactivation of the catalyst by increasing the retard amount, by which the ignition timing is retarded, as the temperature of the first exhaust gas decreases.

The ignition timing retard means may include final ignition timing calculation means for calculating a final ignition timing based on the retard amount, and guard means for changing the final ignition timing to a predetermined guard value when the final ignition timing is more retarded than the predetermined guard value.

With the configuration, when the final ignition timing calculated based on the retard amount is more retarded than the predetermined guard value, the final ignition timing is changed to the guard value. Therefore, it is possible to effectively suppress deterioration of driveability and occurrence of a misfire due to the ignition timing being excessively retarded.

The control apparatus may further include second temperature determination means for determining a temperature of second exhaust gas that flows into the catalyst. The ignition timing retard means may not retard the ignition timing, when the temperature of the second exhaust gas is above a second predetermined value.

When the temperature of the second exhaust gas is above the second predetermined value, the ignition timing is not retarded. When the temperature of the second exhaust gas is high, that is, the temperature of the exhaust gas that flows into the catalyst is high, there is no possibility that the catalyst may be deactivated. Thus, when there is no possibility that the catalyst may be deactivated, the ignition timing is not retarded. Therefore, it is possible to effectively avoid the situation where the ignition timing is excessively retarded, and therefore, the fuel efficiency deteriorates.

A second aspect of the invention relates to a control apparatus for an internal combustion engine, which includes: a plurality of cylinders each of which includes a first exhaust passage connected to a turbine of a turbocharger, a first exhaust valve that opens/closes the first exhaust passage, a second exhaust passage that leads to a position downstream of the turbine, and a second exhaust valve that opens/closes the second exhaust passage; a first catalyst disposed in a third exhaust passage that is located downstream of a first join point at which the first exhaust passages are joined to the second exhaust passages; catalyst warming-up means for warming up the first catalyst by closing the first exhaust valves, and opening the second exhaust valves, during a cold start of the internal combustion engine; and first turbocharger drive means for dividing the cylinders into two cylinder groups, selecting one of the cylinder groups, and opening the first exhaust valves in the selected cylinder group to drive the turbocharger, when warming-up of the catalyst is completed.

When the exhaust gas flows into the first exhaust passage with a large heat capacity according to the request for the turbo flow mode, i.e., the request for supplying the exhaust gas to the turbocharger, the temperature of the exhaust gas is sharply decreased. Therefore, if the exhaust gas, whose temperature has been decreased, flows into the first catalyst, the temperature of the first catalyst may be sharply decreased, and the first catalyst may be deactivated. According to the second aspect, when the request for the turbo flow mode is output, one of the two cylinder groups, into which the cylinders are divided, is selected, and the first exhaust valves in the selected cylinder group are opened. Thus, the amount of the exhaust gas that flows to the turbocharger is limited, as compared to when the first exhaust valves in all the cylinder groups are opened. Therefore, it is possible to satisfy the request for warming up the turbocharger or the required engine output to some degree, while suppressing the deactivation of the first catalyst due to a sharp decrease in the temperature of the exhaust gas.

In the control apparatus, the turbocharger and the first catalyst may be provided for each of the cylinder groups; the third exhaust passage may be provided for each of the cylinder groups, and the third exhaust passages may be joined together at a second join point downstream of the first catalysts; and the control apparatus may further includes a second catalyst that is disposed in a fourth exhaust passage downstream of the second join point at which the third exhaust passages are joined together, second-catalyst-temperature correlation value determination means for determining a second-catalyst-temperature correlation value that is correlated with a temperature of the second catalyst, and second turbocharger drive means for opening the first exhaust valves in the cylinder group that is not selected by the first turbocharger drive means, to drive the turbocharger for the cylinder group that is not selected by the first turbocharger drive means, when the second-catalyst-temperature correlation value is equal to or above a predetermined value.

With the above-described configuration, in the internal combustion engine where the turbocharger and the first catalyst are provided for each of the cylinder groups, the second catalyst is further disposed downstream of the second join point at which the third exhaust passages, which are provided for the respective cylinder groups, are joined together. In the internal combustion engine, first, the exhaust valves in selected one of the cylinder groups are placed in the turbo flow mode. Then, when the warming-up of the second catalyst is completed, the exhaust valves in the other cylinder group are placed in the turbo flow mode. Therefore, the exhaust gas from the cylinder group where the exhaust valves are not in the turbo flow mode, that is, the exhaust gas that bypasses the turbocharger is introduced into the second catalyst during a period until the second catalyst is warmed up. This promotes the warming-up of the second catalyst. Thus, it is possible to effectively suppress the deterioration of the exhaust emissions.

The turbocharger and the first catalyst may be provided for each of the cylinder groups; and the first turbocharger drive means may open the first exhaust valves in both of the cylinder groups to drive the turbochargers, when a required output of the internal combustion engine is equal to or above a predetermined value.

First, the exhaust valves in selected one of the cylinder groups are placed in the turbo flow mode. Then, when the required output is equal to or above the predetermined value, the exhaust valves in all the cylinder groups are placed in the turbo flow mode. If the turbocharger is warmed up while the air amount is large, the temperature of the exhaust gas is unlikely to be decreased. Therefore, it is possible to effectively suppress the deactivation of the first catalysts due to a decrease in the temperature of the exhaust gas, while giving priority to providing the required output.

Heat capacities of exhaust systems of the two cylinder groups may be equal to each other; and the first turbocharger drive means may open the first exhaust valves in one of the two cylinder groups, which is not selected by the first turbocharger drive means in an immediately preceding trip.

When the request for placing the exhaust valves in one of the cylinder groups in the turbo flow mode is output, the cylinder group, which is not the cylinder group selected in the immediately preceding trip, is selected, and the exhaust valves in the selected cylinder group are placed in the turbo flow mode. Therefore, it is possible to equalize the degrees of deterioration of the first catalysts provided for the respective cylinder groups.

The first turbocharger drive means may open the first exhaust valves in one of the two cylinder groups, whose exhaust system has a smaller heat capacity than that of an exhaust system of the other of the two cylinder groups, when the internal combustion engine is started.

First, one of the cylinder groups, whose exhaust system has a smaller heat capacity than that of the exhaust system of the other of the cylinder groups, is selected, and the exhaust valves in the selected cylinder group are placed in the turbo flow mode. Therefore, during a period in which emission purification efficiency of the second catalyst is low, it is possible to minimize a decrease in the temperature of the exhaust gas, and to maintain the emission purification efficiency of the second catalyst at a high level.

A third aspect of the invention relates to a method of controlling an internal combustion engine. The method includes: opening a first exhaust valve that opens/closes a first exhaust passage connected to a turbine of a turbocharger, to drive the turbocharger; determining a catalyst-temperature correlation value that is correlated with a temperature of a catalyst that is disposed in a third exhaust passage located downstream of a join point at which the first exhaust passage is joined to a second exhaust passage that leads to a position downstream of the turbine of the turbocharger, wherein a second exhaust valve opens/closes the second exhaust passage; and retarding an ignition timing, if the catalyst-temperature correlation value is below a predetermined value when the first exhaust valve is opened.

A fourth aspect of the invention relates to a method of controlling an internal combustion engine that includes a plurality of cylinders each of which includes a first exhaust passage connected to a turbine of a turbocharger, a first exhaust valve that opens/closes the first exhaust passage, a second exhaust passage that leads to a position downstream of the turbine, and a second exhaust valve that opens/closes the second exhaust passage. The method includes: warming-up a first catalyst disposed in a third exhaust passage located downstream of a join point at which the first exhaust passages are joined to the second exhaust passages, by closing the first exhaust valves, and opening the second exhaust valves, during a cold start of the internal combustion engine; and dividing the cylinders into two cylinder groups, selecting one of the cylinder groups, and opening the first exhaust valves in the selected cylinder group, to drive the turbocharger, when warming-up of the first catalyst is completed.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a diagram schematically illustrating a configuration of a system according to a first embodiment of the invention;

FIG. 2 is a timing chart showing changes in state amounts when an ignition timing retard correction is executed;

FIG. 3 shows a map which is used to determine a retard amount, and which is stored in an ECU 30;

FIG. 4 is a flowchart showing a routine executed in the first embodiment of the invention;

FIG. 5 is a diagram schematically illustrating a configuration of a system according to a second embodiment of the invention;

FIG. 6 is a flowchart showing a routine executed in the second embodiment of the invention;

FIG. 7 is a diagram schematically illustrating a configuration of a system according to a third embodiment of the invention; and

FIG. 8 is a flowchart showing a routine executed in the third embodiment of the invention.

### DETAILED DESCRIPTION OF EMBODIMENTS

Hereinafter, embodiments of the invention will be described with reference to the drawings. The same and corresponding elements in the drawings are denoted by the same reference numerals, and the repeated description thereof will be omitted. The invention is not limited to the embodiments described below.

### First Embodiment

### [Configuration of First Embodiment]

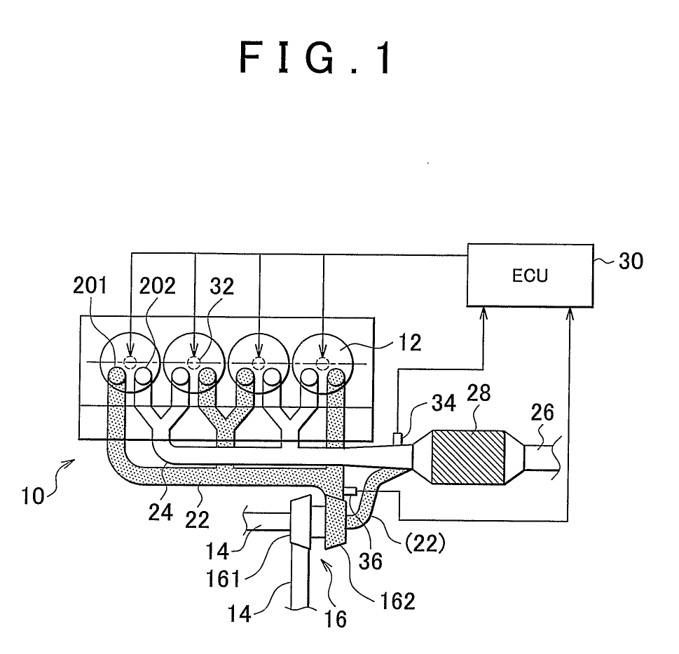

FIG. 1 is a diagram illustrating a structure of a system according to a first embodiment of the invention. The system according to the embodiment is configured as an engine system with an independent exhaust system, which includes a turbocharger.

As shown in FIG. 1, the system according to the embodiment includes an internal combustion engine (hereinafter, simply referred to as “engine”) 10. The engine 10 is configured as a spark-ignition V-8 engine that includes a plurality of cylinders 12. FIG. 1 shows a configuration of only one bank (four cylinders). An intake valve (not shown) is provided in an intake port of each cylinder 12. The intake port is connected to an intake passage 14 through an intake manifold. A compressor 161 of a turbocharger 16 is provided in an upstream portion of the intake passage 14. The compressor 161 is connected to a turbine 162 through a connection shaft (not shown). The turbine 162 is provided in a first exhaust passage 22 (described later). When the turbine 162 is rotated by exhaust gas dynamic pressure (exhaust gas energy), the compressor 161 is driven, and intake air is supercharged. The detailed description of other portions of the configuration of an intake system will be omitted.

A first exhaust valve 201 and a second exhaust valve 202 are disposed in respective exhaust ports of each cylinder 12. The exhaust port, in which the first exhaust valve 201 is disposed, is connected to the first exhaust passage 22 connected to the turbine 162 of the turbocharger 16. The exhaust port, in which the second exhaust valve 202 is disposed, is connected to a second exhaust passage 24 that is not connected to the turbine 162. The second exhaust passage 24 is joined to a portion of the first exhaust passage 22, which is downstream of the turbocharger 16. An exhaust gas purification catalyst (hereinafter, simply referred to as “catalyst”) 28 is disposed in an exhaust passage 26 that is located downstream of the join point at which the second exhaust passage 24 is joined to the first exhaust passage 22. The catalyst 28 is a three-way catalyst. The catalyst 28 simultaneously removes CO, HC (hydrocarbon), and NOx, which are pollutants in exhaust gas, at an air-fuel ratio near the stoichiometric air-fuel ratio.

An ignition plug 32 is disposed for each cylinder 12 of the engine 10. An exhaust gas temperature sensor 34 is disposed in the exhaust passage 26 at a position close to, and upstream of the catalyst 28. The exhaust gas temperature sensor 34 detects a temperature Tc of exhaust gas that flows into the catalyst 28 (hereinafter, the exhaust gas will be referred to as “catalyst IN gas”). An exhaust gas temperature sensor 36 is disposed in the second exhaust passage 24 at a position close to, and upstream of the turbocharger 16. The exhaust gas temperature sensor 36 detects a temperature Tt of exhaust gas that is introduced into the turbine 162 (hereinafter, the exhaust gas will be referred to as “turbo IN gas”).

An electronic control unit (ECU) 30 is provided for the engine 10 according to the embodiment. The ECU 30 is a control apparatus for the engine 10. Various devices, such as the ignition plug 32, are connected to an output portion of the ECU 30. Various sensors, such as the exhaust gas temperature sensors 34 and 36, are connected to an input portion of the ECU 30. The ECU 30 drives the devices based on outputs from the sensors, according to predetermined control programs.

### [Operation in First Embodiment]

Next, operation in the first embodiment will be described with reference to FIG. 1. As shown in FIG. 1, the system according to the embodiment includes the catalyst 28 that removes CO, HC, and NOx contained in the exhaust gas. The catalyst 28 cannot provide sufficient purification performance unless the temperature of the catalyst 28 reaches an activation temperature (approximately 350 to 400° C.). Therefore, it is preferable to quickly warm up the catalyst 28 to the activation temperature, after the engine 10 is started.

As shown in FIG. 1, the engine 10 is configured as an engine with an independent exhaust system. In the engine 10 according to the embodiment, the first exhaust valves 201 are closed (stopped), and the second exhaust valves 202 are opened during a cold start. Thus, the exhaust gas bypasses the turbine 162, and flows to the catalyst 28. As a result, a heat capacity of the exhaust system is decreased, that is, the heat capacity of the exhaust system of the engine 10 becomes equal to the heat capacity of an exhaust system of an engine that does not include a turbocharger. This improves performance of warming up the catalyst 28. Hereinafter, this valve opening mode will be referred to as “NA (Natural Aspiration) flow mode”.

After the warming-up of the catalyst 28 is completed, the valve opening mode is set to a turbo flow mode, that is, the first exhaust valves 201 are opened, and the second exhaust valves 202 are closed (stopped), and thus, the entire amount of the exhaust gas is introduced to the turbine 162. As a result, the supercharging pressure is increased. This effectively improves the response of the turbocharger 16.

However, the turbine 162 with a large heat capacity, and the first exhaust passage 22 where the turbine 162 is disposed are cold, during an engine start (particularly, during a cold start). Therefore, if the exhaust valves 201 and 202 are placed in the turbo flow mode after the warming-up of the catalyst 28 is completed, the temperature of the catalyst IN gas is sharply decreased. Accordingly, if the low-temperature catalyst IN gas, whose temperature has been decreased, flows into the catalyst 28, the bed temperature of the catalyst 28 is sharply decreased, and the catalyst 28 is deactivated. As a result, the characteristics of exhaust emissions may deteriorate.

Accordingly, in the embodiment, ignition timing retard correction is executed, that is, ignition timing is corrected to be retarded during a period in which the exhaust valves 201 and 202 are placed in the turbo flow mode during a cold start. More specifically, when the temperature Tc of the catalyst IN gas is a temperature at which the catalyst 28 is deactivated, the ignition timing retard correction is executed. This increases the temperature of the turbo IN gas. Therefore, it is possible to suppress a decrease in the temperature of the catalyst IN gas. However, when the ignition timing is retarded, for example, the output may be decreased, and the fuel efficiency may be decreased, although the temperature of the exhaust gas is increased. Therefore, it is required to appropriately determine whether the ignition timing retard correction should be executed, and to appropriately set a retard amount by which the ignition timing is retarded, according to, for example, the warmed-up state of the turbocharger 16.

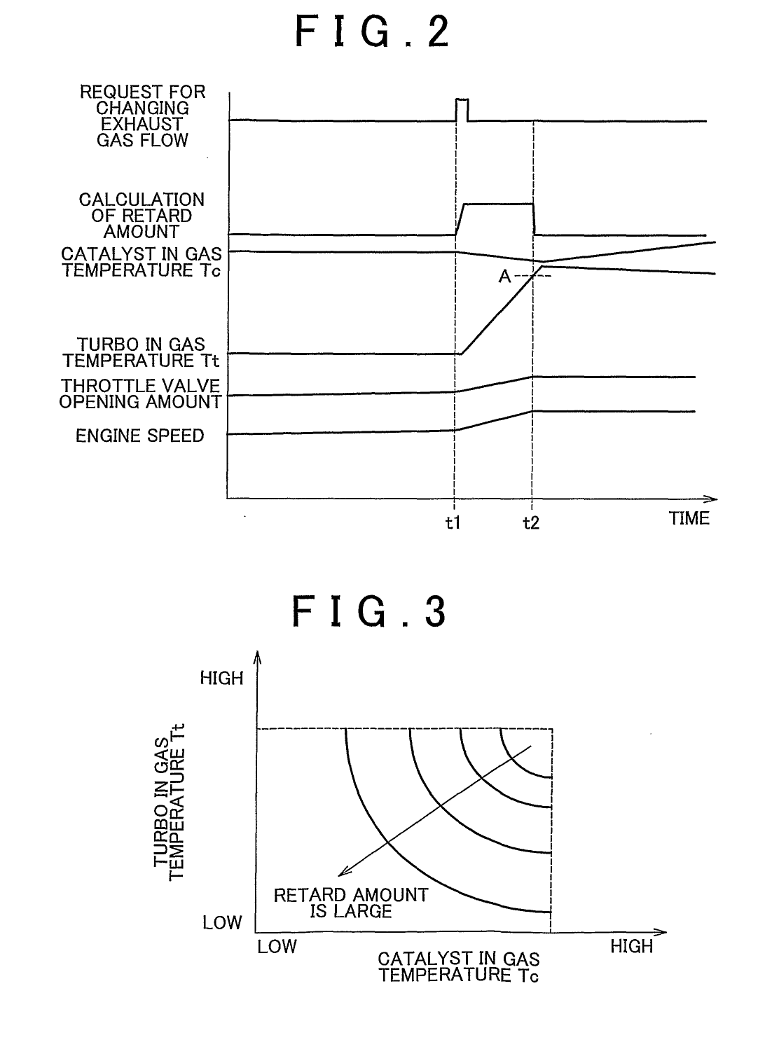

FIG. 2 is a timing chart showing changes in various state amounts when the ignition timing retard correction is executed. As shown in FIG. 2, when a request for setting the valve opening mode to the turbo flow mode (hereinafter, simply referred to as “request for the turbo flow mode”) is output at time point t1, the ignition timing retard correction is started, and it is permitted to switch the valve opening mode to the turbo flow mode. Thus, the turbo IN gas temperature Tt is gradually increased, and a decrease in the catalyst IN gas temperature Tc is suppressed. When the turbo IN gas temperature Tt reaches a predetermined value A at time point t2, the ignition timing retard correction is stopped. The predetermined value A is set in advance to a temperature at which the catalyst 28 is not deactivated even if the ignition timing is set to a normal ignition timing. Thus, it is possible to effectively avoid the situation where the ignition timing is excessively retarded, and therefore, the fuel efficiency deteriorates, and exhaust emissions deteriorate.

Also, the retard amount, by which the ignition timing is retarded, is set based on the turbo IN gas temperature Tt and the catalyst IN gas temperature Tc. FIG. 3 shows a map which is used to set the retard amount, and which is stored in the ECU 30. The retard amount is set according to the map. More specifically, as the turbo IN gas temperature Tt decreases, the retard amount is increased. As the catalyst IN gas temperature Tc decreases, the retard amount is increased. Thus, it is possible to effectively avoid the situation where the ignition timing is excessively retarded, and therefore, the fuel efficiency deteriorates, and exhaust emissions deteriorate.

### [Specific Processes in the First Embodiment]

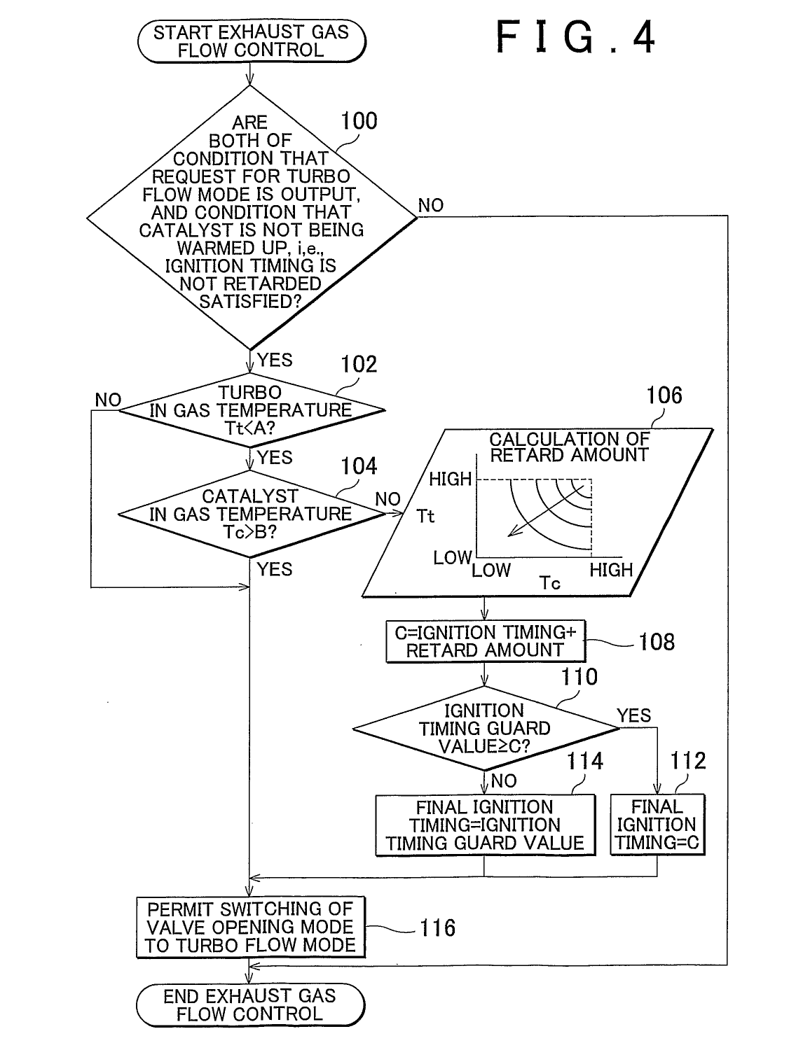

Next, specific processes executed in the first embodiment will be described with reference to FIG. 4. FIG. 4 is a flowchart showing a routine executed by the ECU 30.

In the routine shown in FIG. 4, first, it is determined whether the request for the turbo flow mode is output (step 100). More specifically, it is determined whether a request for providing a high output by driving the turbocharger 16, or a turbocharger warming-up request for warming up the first exhaust passage 22 and the turbine 162 is output. In step 100, it is also determined whether the catalyst 28 is being warmed up. More specifically, it is determined whether the ignition timing retard correction for warming-up of the catalyst 28 is being executed. When it is determined that the request for the turbo flow mode is not output, or when it is determined that the catalyst 28 is being warmed up, the routine is quickly ended.

When it is determined that the request for the turbo flow mode is output, and the catalyst 28 is not being warmed up in step 100, the routine proceeds to the next step (step 102). In step 102, it is determined whether the warming-up of the turbocharger 16 has been completed. More specifically, it is determined whether the turbo IN gas temperature Tt is below the predetermined value A. The predetermined value A is set in advance so that when the turbo IN gas temperature Tt is equal to or above the predetermined value A, it is determined that the warming-up of the turbocharger 16 has been completed. The turbo IN gas temperature Tt is detected by the exhaust gas temperature sensor 36.

When it is determined that the turbo IN gas temperature Tt is below the predetermined value A (Tt<A), it is determined that the warming-up of the turbocharger 16 has not been completed, and the routine proceeds to the next step (step 104). In step 104, it is determined whether there is a possibility that the catalyst 28 may be deactivated. More specifically, it is determined whether the catalyst IN gas temperature Tc is above a predetermined value B. The predetermined value B is set in advance so that when the catalyst IN gas temperature Tc is equal to or below the predetermined value B, the catalyst 28 is deactivated. The catalyst IN gas temperature Tc is detected by the exhaust gas temperature sensor 34. When it is determined that the catalyst IN gas temperature Tc is above the predetermined value B (Tc>B), it is determined that there is no possibility that the catalyst 28 may be deactivated if the exhaust valves 201 and 202 are placed in the turbo flow mode. Thus, it is permitted to switch the valve opening mode to the turbo flow mode in step 116 (described later).

When it is determined that the catalyst IN gas temperature Tc is equal to or below the predetermined value B (Tc≦B) in step 104, it is determined that there is a possibility that the catalyst 28 may be deactivated if the exhaust valves 201 and 202 are placed in the turbo flow mode. Therefore, the routine proceeds to the next step (step 106). In step 106, the retard amount in the ignition timing retard correction is determined. The map shown in FIG. 3 is stored in the ECU 30. More specifically, the retard amount corresponding to the turbo IN gas temperature Tt detected in step 102, and the catalyst IN gas temperature Tc detected in step 104 is determined based on the map.

Next, an ignition timing C is calculated (step 108). More specifically, the ignition timing C is calculated by adding the retard amount determined in step 106 to an ignition timing calculated based on the operating state of the engine 10.

Next, it is determined whether the ignition timing C is equal to or below a guard value of the ignition timing (step 110). The guard value is set in advance to a limit value at and below which the deterioration of the fuel efficiency is permitted, and the deterioration of exhaust emissions is permitted. When it is determined that the ignition timing C is equal to or below the guard value (the guard value≧the ignition timing C), a final ignition timing is changed to the ignition timing C (step 112). When it is determined that the ignition timing C is above the guard value (the guard value<the ignition timing C), the final ignition timing is changed to the guard value (step 114).

Next, it is permitted to switch the valve opening mode to the turbo flow mode (step 116). More specifically, after the ignition timing retard correction is executed in step 112 or step 114, the routine proceeds to the next step (step 116). In step 116, it is permitted to switch the valve opening mode to the turbo flow mode. More specifically, the first exhaust valves 201 are opened. As a result, the exhaust gas, whose temperature has been increased by retarding the ignition timing, is introduced to the turbine 162. Thus, the routine is ended.

When the routine is repeatedly executed, the warming-up of the turbocharger 16 proceeds, and the turbo IN gas temperature Tt is gradually increased. When the turbo IN gas temperature Tt reaches the predetermined value A used to determine that the warming-up of the turbocharger 16 has been completed, it is determined that the turbo IN gas temperature Tt is equal to or above the predetermined value A in step 102. Thus, the ignition timing retard correction is not executed, and in step 116, it is permitted to switch the valve opening mode to the turbo flow mode.

As described above, according to the first embodiment, when the request for the turbo flow mode is output, and there is a possibility that the catalyst 28 may be deactivated, the ignition timing is retarded, and then, it is permitted to switch the valve opening mode to the turbo flow mode. Therefore, it is possible to effectively suppress the deactivation of the catalyst 28.

Also, according to the first embodiment, as the catalyst IN gas temperature Tc decreases, and as the turbo IN gas temperature Tt decreases, the retard amount, by which the ignition timing is retarded, is calculated to be increased. Therefore, it is possible to effectively suppress the deactivation of the catalyst 28.

Also, according to the first embodiment, the ignition timing is guarded by the predetermined guard value. Therefore, it is possible to effectively suppress deterioration of driveability and occurrence of a misfire due to the ignition timing being excessively retarded.

In the above-described first embodiment, the detection signal from the exhaust gas temperature sensor 34 is used to determine the catalyst IN gas temperature Tc. However, the method of determining the catalyst IN gas temperature Tc is not limited to this method. That is, the catalyst IN gas temperature Tc may be estimated based on a correlation between the catalyst IN gas temperature Tc, and an accumulated amount of intake air, an engine speed, and an engine load. Also, instead of the catalyst IN gas temperature Tc, the bed temperature of the catalyst 28 detected directly by a temperature sensor disposed in the catalyst 28 may be used for the control.

In the above-described first embodiment, when the request for the turbo flow mode is output, the first exhaust valves 201 are opened, and the second exhaust valves 202 are closed (stopped) to introduce the entire amount of the exhaust gas to the turbine 162. However, the turbo flow mode is not limited to this mode. In the turbo flow mode, the first exhaust valves 201 and the second exhaust valves 202 may be opened to introduce part of the exhaust gas to the turbine 162.

In the first embodiment, the catalyst IN gas temperature Tc may be regarded as “the catalyst-temperature correlation value” according to the invention. The exhaust gas temperature sensor 34 may be regarded as “the catalyst-temperature correlation value determination means” according to the invention. The processes in step 104 to step 114 executed by the ECU 30 may be regarded as the processes executed by “the ignition timing retard means” according to the invention. The process in step 116 executed by the ECU 30 may be regarded as the process executed by “the turbocharger drive means” according to the invention.

Also, in the above-described first embodiment, the process in step 106 executed by the ECU 30 may be regarded as the process executed by “the retard amount calculation means” according to the invention.

Also, in the above-described first embodiment, the turbo IN gas temperature Tt may be regarded as “the temperature of the first exhaust gas” according to the invention. The exhaust gas temperature sensor 36 may be regarded as “the first temperature determination means” according to the invention. The process in step 106 executed by the ECU 30 may be regarded as the process executed by “the retard amount calculation means” according to the invention.

In the above-described first embodiment, the process in step 106 executed by the ECU 30 may be regarded as the process executed by “the retard amount calculation means” according to the invention. The process in step 108 executed by the ECU 30 may be regarded as the process executed by “the final ignition timing calculation means”. The process in step 110 executed by the ECU 30 may be regarded as the process executed by “the guard means” according to the invention.

Also, in the above-described first embodiment, the turbo IN gas temperature Tt may be regarded as “the temperature of the first exhaust gas” according to the invention. The exhaust gas temperature sensor 36 may be regarded as “the first temperature determination means” according to the invention. The process in step 102 executed by the ECU 30 may be regarded as the process executed by “the prohibition means” according to the invention.

### Second Embodiment

### [Configuration of Second Embodiment]

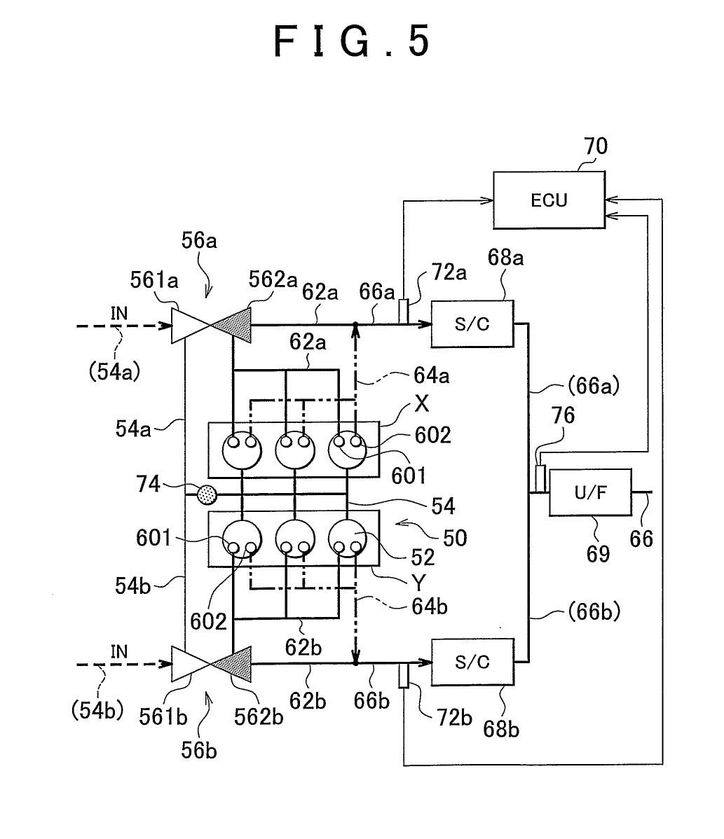

FIG. 5 is a diagram illustrating a structure of a system according to a second embodiment of the invention. The system according to the second embodiment is configured as an engine system with an independent exhaust system, which includes two turbochargers.

As shown in FIG. 5, the system according to the second embodiment includes an internal combustion engine (hereinafter, referred to simply as “engine”) 50. The engine 50 is configured as a V-6 engine that includes a plurality of cylinders 52. An intake valve (not shown) is provided in an intake port of each cylinder 52. The intake port is connected to an intake passage 54 through an intake manifold. A throttle 74 is disposed in an upstream portion of the intake passage 54. A portion of the intake passage 54 upstream of the throttle 74 is branched into a first intake passage 54a and a second intake passage 54b. A compressor 561a of a turbocharger 56a is provided in an upstream portion of the first intake passage 54a. A compressor 561b of a turbocharger 56b is provided in an upstream portion of the second intake passage 54b. The compressors 561a and 561b are connected to turbines 562a and 562b, respectively, through respective connection shafts (not shown). The turbines 562a and 562b are provided in first exhaust passages 62a and 62b (described later), respectively. When the turbines 562a and 562b are rotated by exhaust gas dynamic pressure (exhaust gas energy), the compressors 561a and 561b are driven, and intake air is supercharged. The detailed description of the other portions of the configuration of the intake system will be omitted.

A first exhaust valve 601 and a second exhaust valve 602 are disposed in respective exhaust ports of each cylinder 12. In one bank (bank X) of the engine 50, the exhaust port, in which the first exhaust valve 601 is disposed, is connected to the first exhaust passage 62a connected to the turbine 562a of the turbocharger 56a. The exhaust port, in which the second exhaust valve 602 is disposed, is connected to a second exhaust passage 64a that is not connected to the turbine 562a. The second exhaust passage 64a is joined to a portion of the first exhaust passage 62a downstream of the turbocharger 56a. A start catalyst (hereinafter, may be referred to as “S/C catalyst”) 68a is disposed in an exhaust passage 66a that is located downstream of the join point at which the second exhaust passage 64a is joined to the first exhaust passage 62a. The S/C catalyst 68a is a three-way catalyst. The S/C catalyst 68a simultaneously removes CO, HC, and NOx, which are pollutants in the exhaust gas, at an air-fuel ratio near the stoichiometric air-fuel ratio. An exhaust gas sensor 72a is disposed in the exhaust passage 66a at a position close to, and upstream of the S/C catalyst 68a. The exhaust gas temperature sensor 72a detects a temperature Tsca of exhaust gas that flows into the SIC catalyst 68a (hereinafter, the exhaust gas will be referred to as “S/C catalyst IN gas”). As shown in FIG. 5, for a bank Y of the engine 50, the same exhaust system configuration as the exhaust system configuration for the bank X is provided. That is, a first exhaust passage 62b, a second exhaust passage 64b, an exhaust passage 66b, a S/C catalyst 68b, and an exhaust gas temperature sensor 72b are provided.

A portion of the exhaust passage 66a downstream of the S/C catalyst 68a is joined to a portion of the exhaust passage 66b downstream of the S/C catalyst 68b. A downstream catalyst (hereinafter, may be referred to as “U/F catalyst”) 69 is disposed in an exhaust passage 66 that is located downstream of the join point at which the exhaust passage 66a is joined to the exhaust passage 66b. The U/F catalyst 69 is configured as the three-way catalyst, as well as the S/C catalyst 68. An exhaust gas temperature sensor 76 is disposed in the exhaust passage 66 at a position close to, and upstream of the U/F catalyst 69. The exhaust gas temperature sensor 76 detects a temperature Tuf of exhaust gas that flows into the U/F catalyst 69 (hereinafter, the exhaust gas will be referred to as “U/F catalyst IN gas”).

An electronic control unit (ECU) 70 is provided for the engine 50 according to the embodiment. The ECU 70 is a control apparatus for the engine 50. Various devices are connected to an output portion of the ECU 70. Various sensors, such as the exhaust gas temperature sensors 72a, 72b, and 76, are connected to an input portion of the ECU 70. The ECU 70 drives the devices based on outputs from the sensors, according to predetermined control programs.

### [Characteristic Operation in Second Embodiment]

Next, operation in the second embodiment will be described with reference to FIG. 5. In the system according to the above-described first embodiment, when the request for the turbo flow mode is output, and there is a possibility that the catalyst 28 may be deactivated, the ignition timing is retarded, and it is permitted to switch the valve opening mode to the turbo flow mode. Thus, it is possible to effectively suppress the deactivation of the catalyst 28 due to a decrease in the temperature of the catalyst 28.

In contrast, in the second embodiment, a condition for placing the exhaust valves 601 and 602 in the turbo flow mode is set for each bank. Hereinafter, operation in the second embodiment will be described in detail.

As shown in FIG. 5, the system according to the second embodiment includes the S/C catalysts 68a and 68b for the respective banks. During the cold start of the engine 50, first, the S/C catalysts 68a and 68b are warmed up. More specifically, the valve opening mode in each of the bank X and the bank Y is set to the NA flow mode. Thus, the heat capacity of the exhaust route of each bank becomes equal to that in a natural aspiration engine. This improves the performance of warming up the S/C catalysts 68a and 68b.

After the warming-up of the S/C catalysts 68a and 68b is completed by setting the valve opening mode to the NA flow mode, the request for the turbo flow mode is output based on the request for warming up the turbines 562a and 562b, or the required engine output. If the exhaust valves 601 and 602 in the both banks are simultaneously placed in the turbo flow mode, the purification performance of the S/C catalyst 68a and the purification performance of the S/C catalyst 68b are simultaneously decreased. This may deteriorate exhaust emissions. Also, the temperature of the exhaust gas introduced into the U/F catalyst 69 is sharply decreased. This may interfere with the warming-up of the U/F catalyst 69.

Thus, in the system according to the second embodiment, when the request for warming up the turbines 562a and 562b is output, the exhaust valves 601 and 602 in the both banks are not simultaneously placed in the turbo flow mode. Instead, the condition for placing the exhaust valves 601 and 602 in the turbo flow mode is set for each bank. More specifically, when the exhaust valves 601 and 602 in the selected bank (for example, the bank X) are placed in the turbo flow mode, the exhaust valves 601 and 602 in the bank Y remain in the NA flow mode. Thus, it is possible to warm up the U/F catalyst 69, while suppressing a decrease in the temperature of the S/C catalyst 68b. Therefore, it is possible to warm up the turbine 562a, while suppressing the deterioration of exhaust emissions.

The exhaust valves 601 and 602 in the bank Y are placed in the turbo flow mode after the warming-up of the U/F catalyst 69 is completed. After the warming-up of the U/F catalyst 69 is completed, it is possible to maintain emission purification efficiency at a high level, even if the purification performance of the S/C catalyst 68b is decreased due to a decrease in the temperature of the S/C catalyst 68b. Accordingly, it is possible to warm up the turbine 562a and 562b, while suppressing the deterioration of exhaust emissions.

The exhaust valves 601 and 602 in the bank Y may be placed in the turbo flow mode when the required output is equal to or above a predetermined value. That is, if the exhaust valves 601 and 602 are in the turbo flow mode while the air amount is large, it is possible to warm up the turbochargers 56a and 56b, while suppressing a decrease in the temperature of the S/C catalysts 68a and 68b. Therefore, it is possible to warm up the turbines 562a and 562b, while suppressing the deterioration of exhaust emissions, even if the warming-up of the U/F catalyst 69 has not been completed.

### [Specific Processes in the Second Embodiment]

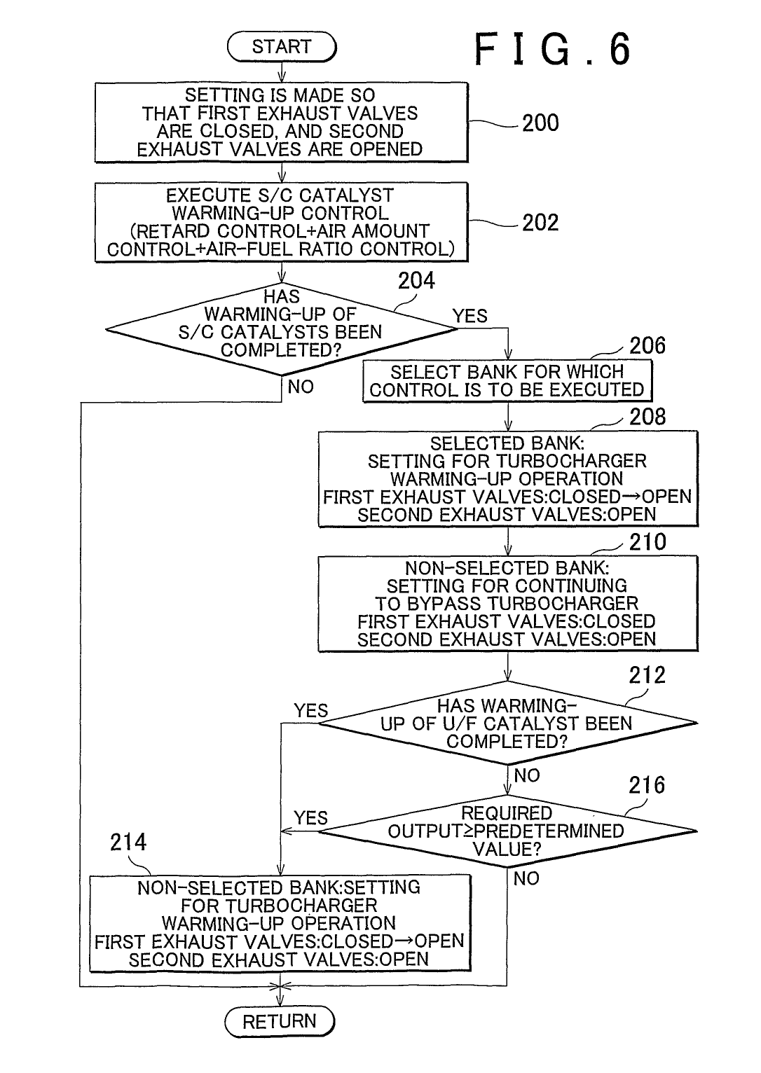

Next, specific processes executed in the second embodiment will be described with reference to FIG. 6. FIG. 6 is a flowchart showing a routine executed by the ECU 70 during the cold start of the engine 50.

In the routine shown in FIG. 6, first, the valve opening mode is set to the NA flow mode (step 200). More specifically, in each of the bank X and the bank Y, the first exhaust valves 601 are closed, and the second exhaust valves 602 are opened. Thus, the exhaust valves 601 and 602 in the both banks are simultaneously placed in the NA flow mode. Next, controls that warm up the S/C catalysts 68a and 68b are executed (step 202). More specifically, as the controls that promote the warming-up of the S/C catalysts 68a and 68b, for example, a control that retards the ignition timing, a control that makes the air-fuel ratio rich, and an air amount control are executed.

Next, it is determined whether the warming-up of the S/C catalysts 68a and 68b has been completed (step 204). More specifically, the warmed-up state of the S/C catalysts 68a and 68b is determined based on the detection signals from the exhaust gas temperature sensors 72a and 72b. When it is determined that the warming-up of the S/C catalysts 68a and 68b has not been completed, the routine is quickly ended. When it is determined that the warming-up of the S/C catalysts 68a and 68b has been completed, it is determined that a turbocharger warming-up control can be executed, and the routine proceeds to the next step (step 206). In step 206, the bank, in which the exhaust valves 601 and 602 should be placed in the turbo flow mode, is selected. More specifically, the bank, which is different from the bank selected in step 206 in an immediately preceding trip, is selected. The trip is a period from a start of the internal combustion engine until a stop of the internal combustion engine.

Next, the exhaust valves 601 and 602 in the bank selected in step 206 (for example, the bank X) are placed in the turbo flow mode (step 208). More specifically, the first exhaust valves 601 in the bank X are opened to warm up the turbocharger 56a. In contrast, the exhaust valves 601 and 602 in the bank Y that is not selected in step 206 remain in the NA flow mode (step 210). Thus, the S/C catalyst 68b continues to be warmed up, and the U/F catalyst 69 is warmed up.

Next, it is determined whether the warming-up of the U/F catalyst 69 has been completed (step 212). More specifically, it is determined whether the warmed-up state of the U/F catalyst 69 is determined based on the detection signal from the exhaust gas temperature sensor 76. When it is determined that the warming-up of the U/F catalyst 69 has been already completed, it is determined that no problem will occur if the exhaust valves 601 and 602 in the bank Y are placed in the turbo flow mode, and the routine proceeds to the next step (step 214). In step 214, the exhaust valves 601 and 602 in the bank Y are placed in the turbo flow mode (step 214). More specifically, the first exhaust valves 601 in the bank Y are opened to warm up the turbocharger 56b.

When it is determined that the warming-up of the U/F catalyst 69 has not been completed in step 212, it is determined that exhaust emissions will deteriorate if the exhaust valves 601 and 602 in the bank Y are placed in the turbo flow mode, and the routine proceeds to the next step (step 216). In step 216, it is determined whether the required output is equal to or above a predetermined value. If the exhaust valves 601 and 602 are in the turbo flow mode while the air amount is large, it is possible to warm up the turbochargers 56a and 56b, while suppressing a decrease in the temperature of the SIC catalysts 68a and 68b. More specifically, first, the required output (required air amount) is calculated based on the accelerator pedal operation amount ACCP and the like. Next, the calculated required output is compared with the predetermined value. The predetermined value is an output value corresponding to the maximum amount of air in the turbocharger for one bank. When it is determined that the required output is below the predetermined value, it is determined that the air amount is not large, and therefore, it is not appropriate to place the exhaust valves 601 and 602 in the bank Y in the turbo flow mode. Thus, the routine is promptly ended. When it is determined that the required output is equal to or above the predetermined value in step 212, it is determined that the air amount is large, and therefore, it is appropriate to place the exhaust valves 601 and 602 in the bank Y in the turbo flow mode. Therefore, in step 214, the exhaust valves 601 and 602 in the bank Y are placed in the turbo flow mode.

As described above, according to the second embodiment, when the turbochargers 56a and 56b are warmed up after the cold start of the engine 50, the exhaust valves 601 and 602 in the both banks are not simultaneously placed in the turbo flow mode. First, only the exhaust valves 601 and 602 in one bank (for example, the bank X) are placed in the turbo flow mode. That is, when the turbocharger 56a for the bank X is warmed up, the exhaust valves 601 and 602 in the other bank (for example, the bank Y) remain in the NA flow mode. Therefore, it is possible to continue to warm up the S/C catalyst 68b, and to effectively warm up the U/F catalyst 69. Thus, it is possible to effectively suppress the deterioration of exhaust emissions when the turbocharger 56a is warmed up.

Also, according to the second embodiment, after the warming-up of the U/F catalyst 69 is completed, the exhaust valves 601 and 602, which have remained in the NA flow mode, are placed in the turbo flow mode. Therefore, it is possible to warm up the turbochargers 56a and 56b, while suppressing the deterioration of exhaust emissions.

Also, according to the second embodiment, if the warming-up of the turbocharger for one bank is started earlier than the warming-up of the turbocharger for the other bank in the immediately preceding trip, the warming-up of the turbocharger for the other bank is started earlier than the warming-up of the turbocharger for the one bank in the current trip. Therefore, it is possible to equalize the degrees of deterioration of the S/C catalysts 68a and 68b provided for the respective banks.

Also, according to the second embodiment, when the required output is equal to or above the predetermined value, the exhaust valves 601 and 602, which have remained in the NA flow mode, are placed in the turbo flow mode. If the exhaust valves 601 and 602 are in the turbo flow mode while the air amount is large, it is possible to warm up the turbochargers 56a and 56b, while suppressing a decrease in the temperature of the S/C catalysts 68a and 68b. Therefore, it is possible to warm up the turbochargers 56a and 56b, while suppressing the deterioration of exhaust emissions.

In the above-described second embodiment, the detection signals from the exhaust gas temperature sensors 72a, 72b, and 76 are used to determine the temperature Tsc of the S/C catalyst IN gas, and the temperature Tuf of the U/F catalyst IN gas. However, the method of determining the temperatures Tsc and Tuf is not limited to this method. That is, the temperatures Tsc and Tuf may be estimated based on a correlation between the temperatures Tsc and Tuf, and the accumulated amount of intake air, the engine speed, and the engine load. Instead of the temperature Tsc of the S/C catalyst IN gas and the temperature Tuf of the U/F catalyst IN gas, the bed temperature of the S/C catalyst detected directly by a temperature sensor disposed in the S/C catalyst, and the bed temperature of the U/F catalyst detected directly by a temperature sensor disposed in the U/F catalyst may be used for the control. In a third embodiment (described later) as well, the method of detecting temperatures of catalysts is not limited to a specific method. The bed temperatures of the catalysts detected directly by temperature sensors disposed in the catalysts may be used for the control.

In the above-described second embodiment, when the request for the turbo flow mode is output, the first exhaust valves 601 and the second exhaust valves 602 are opened to introduce the exhaust gas to the turbines 562a and 562b. However, the turbo flow mode is not limited to this mode. In the turbo flow mode, the first exhaust valves 601 may be opened, and the second exhaust valves 602 may be closed (stopped) to introduce the entire amount of the exhaust gas to the turbine 562a of the bank X. In the third embodiment (described later) as well, the turbo flow mode is not limited to a specific mode. That is, in the turbo flow mode, the first exhaust valves 601 may be opened, and the second exhaust valve 602 may be closed (stopped) to introduce the entire amount of the exhaust gas to the turbine 562a of the bank X.

In the above-described second embodiment, the invention is applied to the twin-turbo engine that includes the two turbochargers 56a and 56b. However, the system configuration is not limited to this configuration. That is, a timing at which the exhaust valves are placed in the turbo flow mode may be set for each cylinder group, in a single-turbo engine that includes a single turbocharger. Also, the cylinders need not necessarily be grouped according to the bank. The cylinders may be grouped according to other criteria. In the third embodiment (described later) as well, the cylinders need not necessarily be grouped according to the bank. That is, the cylinders may be grouped according to other criteria.

In the above-described second embodiment, the S/C catalysts 68a and 68b may be regarded as “the first catalyst” according to the invention. The process in step 200 executed by the ECU 70 may be regarded as the process executed by “the catalyst warming-up means” according to the invention. The processes in step 208 and 210 executed by the ECU 70 may be regarded as the process executed by “the first turbocharger drive means” according to the invention.

In the above-described second embodiment, the U/F catalyst 69 may be regarded as “the second catalyst” according to the invention. The U/F catalyst IN gas temperature Tuf may be regarded as “the second-catalyst-temperature correlation value” according to the invention. The process in step 212 executed by the ECU 70 may be regarded as the process executed by “the second-catalyst-temperature correlation value determination means” according to the invention. The processes in step 212 and step 214 executed by the ECU 70 may be regarded as the process executed by “the second turbocharger drive means” according to the invention.

In the above-described second embodiment, the processes in step 214 and step 216 executed by the ECU 70 may be regarded as the process executed by the “second turbocharger drive means” according to the invention.

In the above-described second embodiment, the process in step 206 executed by the ECU 70 may be regarded as the process executed by “the first turbocharger drive means” according to the invention.

### Third Embodiment

### [Characteristics of the Third Embodiment]

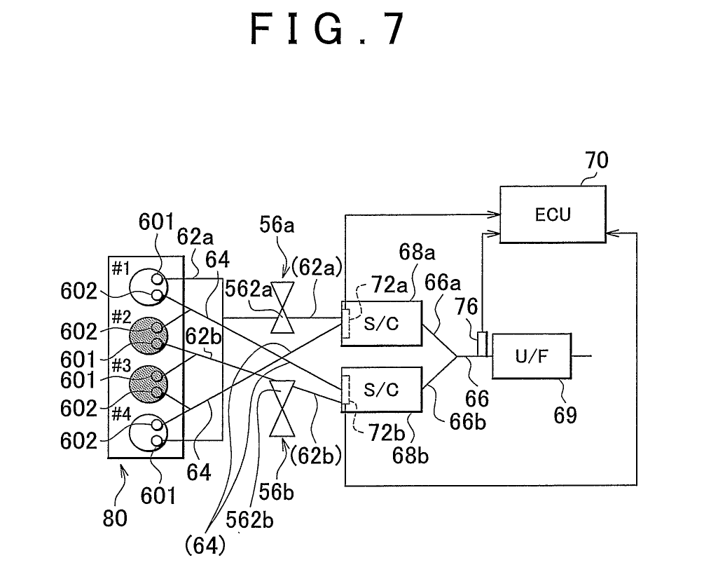

FIG. 7 is a diagram illustrating a structure of a system according to a third embodiment of the invention. The system according to the third embodiment is configured as an engine system with an independent exhaust system, which includes two turbochargers. In FIG. 7, the same and corresponding elements as those in the system shown in FIG. 5 are denoted by the same reference numerals, and the detailed description thereof will be omitted or the description thereof will be simplified.

As shown in FIG. 7, the system according to the third embodiment includes an internal combustion engine (hereinafter, simply referred to as “engine”) 80. The engine 80 is configured as an L-4 engine that includes a plurality of cylinders 52. In a first cylinder group constituted by a first cylinder (#1) and a fourth cylinder (#4), the exhaust ports, in which the first exhaust valves 601 are disposed, are connected to the first exhaust passage 62a connected to the turbine 562a of the turbocharger 56a. In a second cylinder group constituted by a second cylinder (#2) and a third cylinder (#3), the exhaust ports, in which the second exhaust valves 601 are disposed, are connected to the first exhaust passage 62b connected to the turbine 562b of the turbocharger 56b. The length of the first exhaust passage 62a for the first cylinder group is longer than that of the first exhaust passage 62b for the second cylinder group. The exhaust port, in which the second exhaust valve of each cylinder 52 is disposed, is connected to the second exhaust passage 64 that is not connected to the turbines 562a and 562b.

In the system with the above-described configuration, when the exhaust valves 601 and 602 are placed in the turbo flow mode during the cold start, the condition for placing the exhaust valves 601 and 602 in the turbo flow mode is set for each cylinder group, as well as in the above-described second embodiment. In the third embodiment, however, when the request for warming-up the turbines 562a and 562b is output, first, the exhaust valves 601 and 602 in the second cylinder group are placed in the turbo flow mode, and the exhaust valves 601 and 602 remain in the NA flow mode. As described above, the heat capacity of the exhaust system of the first cylinder group is larger than the heat capacity of the exhaust system of the second cylinder group. Therefore, during a period in which the exhaust valves are in the turbo flow mode, in an initial stage in which the warming-up of the U/F catalyst 69 has not proceeded much, it is possible to suppress a decrease in the temperature of the S/C catalysts 68a and 68b, and to effectively warm up the U/F catalyst 69. Accordingly, it is possible to suppress the deterioration of exhaust emissions, and to warm up the turbines 562a and 562b.

### [Specific Processes in the Third Embodiment]

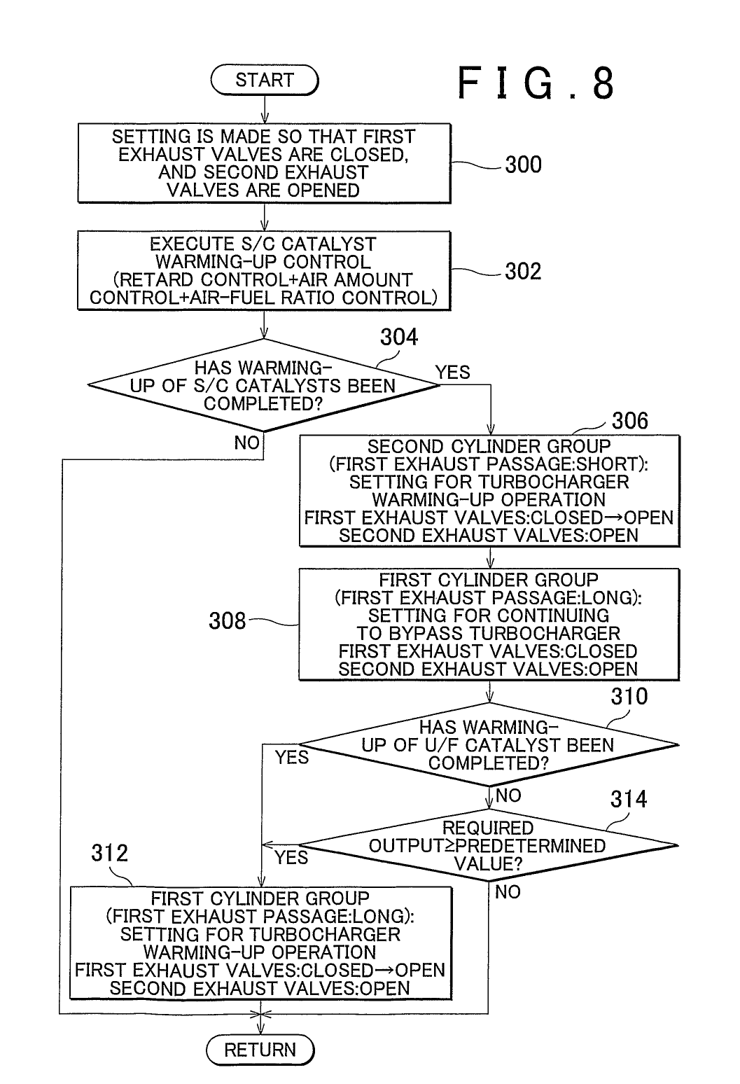

Next, specific processes executed in the third embodiment will be described with reference to FIG. 8. FIG. 8 is a flowchart showing a routine executed by the ECU 70 during the cold start of the engine 80.

In the routine shown in FIG. 8, first, the valve opening mode is set to the NA flow mode (step 300). Then, the controls that warm up the S/C catalysts 68a and 68b are executed (step 302). Then, it is determined whether the warming-up of the S/C catalysts 68a and 68b has been completed (step 304). More specifically, the same processes as those in step 200 to step 204 shown in FIG. 6 are executed. When it is determined that the warming-up has not been completed, the routine is promptly ended. When it is determined that the warming-up has been completed, it is determined that the turbocharger warming-up control can be executed, and the routine proceeds to the next step (step 306). In step 306, the exhaust valves 601 and 602 in the second cylinder group are placed in the turbo flow mode. More specifically, the first exhaust valves 601 in the second cylinder group are opened, and thus, the turbocharger 56b is warmed up. The exhaust valves 601 and 602 in the first cylinder group remain in the NA flow mode (step 308). Thus, it is possible to continue to warm up the S/C catalysts 68a and 68b, and to warm up the U/F catalyst 69.

Then, it is determined whether the warming-up of the U/F catalyst 69 has been completed (step 310). When it is determined that the warming-up of the U/F catalyst 69 has been already completed, it is determined that no problem will occur if the exhaust valves 601 and 602 in the first cylinder group are placed in the turbo flow mode, and the routine proceeds to the next step (step 312). In step 312, the exhaust valves 601 and 602 in the first cylinder group are placed in the turbo flow mode. When it is determined that the warming-up of the U/F catalyst 69 has not been completed in step 310, it is determined that emissions will deteriorate if the exhaust valves 601 and 602 in the first cylinder group are placed in the turbo flow mode, and the routine proceeds to the next step (step 314). In step 314, it is determined whether the required output is equal to or above the predetermined value (step 314). More specifically, the same processes as the processes in step 212 to step 216 in FIG. 6 are executed. When it is determined that the required output is below the predetermined value, it is determined that the air amount is not large, and it is not appropriate to place the exhaust valves 601 and 602 in the first cylinder group in the turbo flow mode, and the routine is promptly ended. When it is determined that the required output is equal to or above the predetermined value in step 314, it is determined that the air amount is large, and it is appropriate to place the exhaust valves 601 and 602 in the first cylinder group in the turbo flow mode. Thus, in step 312, the exhaust valves 601 and 602 in the first cylinder group are placed in the turbo flow mode.

As described above, according to the third embodiment, when the exhaust valves 601 and 602 are placed in the turbo flow mode after the cold start of the engine 80, the exhaust valves 601 and 602 in all the cylinders are not simultaneously placed in the turbo flow mode. Instead, first, only the exhaust valves 601 and 602 in the second cylinder group are placed in the turbo flow mode. The first exhaust passage 62b from the second cylinder group to the S/C catalyst 68b is shorter than the first exhaust passage 62a from the first cylinder group to the S/C catalyst 68a. That is, when the turbocharger 56b for the second cylinder group is being warmed up, the exhaust valves 601 and 602 in the first cylinder group, whose exhaust system has a large heat capacity, remain in the NA flow mode. Therefore, it is possible to continue to warm up the S/C catalysts 68a and 68b, and to effectively warm up the U/F catalyst 69. Thus, it is possible to effectively suppress the deterioration of exhaust emissions when the turbocharger 56b is being warmed up as shown in FIG. 7.

In the above-described third embodiment, the S/C catalysts 68a and 68b may be regarded as “the first catalyst” according to the invention. The process in step 300 executed by the ECU 70 may be regarded as the process executed by “the catalyst warming-up means” according to the invention. The processes in step 306 and step 308 executed by the ECU 70 may be regarded as the process executed by “the first turbocharger drive means” according to the invention.

In the above-described third embodiment, the U/F catalyst 69 may be regarded as “the second catalyst” according to the invention. The U/F catalyst IN gas temperature Tuf may be regarded as “the second-catalyst-temperature correlation value” according to the invention. The process in step 310 executed by the ECU 70 may be regarded as the process executed by “the second-catalyst-temperature correlation value determination means” according to the invention. The processes in step 310 and step 312 executed by the ECU 70 may be regarded as the process executed by “the second turbocharger drive means” according to the invention.

In the above-described third embodiment, the processes in step 312 and step 314 executed by the ECU 70 may be regarded as the process executed by “the second turbocharger drive means” according to the invention.

In the above-described third embodiment, the process in step 306 executed by the ECU 70 may be regarded as “the first turbocharger drive means” according to the invention.

1. A control apparatus for an internal combustion engine, comprising:
a plurality of cylinders each of which includes a first exhaust passage connected to a turbine of a turbocharger, a first exhaust valve that opens/closes the first exhaust passage, a second exhaust passage that leads to a position downstream of the turbine, and a second exhaust valve that opens/closes the second exhaust passage;
a catalyst disposed in a third exhaust passage that is located downstream of a join point at which the first exhaust passages are joined to the second exhaust passages;
catalyst-temperature correlation value determination means for determining a catalyst-temperature correlation value that is correlated with a temperature of the catalyst;
turbocharger drive means for opening the first exhaust valves to drive the turbocharger; and
ignition timing retard means for retarding an ignition timing, if the catalyst-temperature correlation value is below a first predetermined value when the turbocharger drive means opens the first exhaust valves.

2. The control apparatus according to claim 1, wherein the turbocharger drive means opens the first exhaust valves after warming-up of the catalyst is completed.

3. The control apparatus according to claim 1 or 2, wherein the ignition timing retard means includes retard amount calculation means for calculating a retard amount by which the ignition timing is retarded.

4. The control apparatus according to claim 3, wherein the retard amount calculation means calculates the retard amount so that the retard amount increases as the catalyst-temperature correlation value decreases.

5. The control apparatus according to claim 3 or 4, further comprising
first temperature determination means for determining a temperature of first exhaust gas that flows into the turbine, wherein the retard amount calculation means calculates the retard amount so that the retard amount increases as the temperature of the first exhaust gas decreases.

6. The control apparatus according to any one of claims 3 to 5, wherein the ignition timing retard means includes final ignition timing calculation means for calculating a final ignition timing based on the retard amount, and guard means for changing the final ignition timing to a predetermined guard value when the final ignition timing is more retarded than the predetermined guard value.

7. The control apparatus according to any one of claims 1 to 6, further comprising
second temperature determination means for determining a temperature of second exhaust gas that flows into the catalyst, wherein the ignition timing retard means does not retard the ignition timing, when the temperature of the second exhaust gas is above a second predetermined value.

8. The control apparatus according to any one of claims 1 to 7, wherein the first exhaust valve and the second exhaust valve are provided in each of the cylinders.

9. The control apparatus according to claims 1 to 8, wherein the second exhaust passages are directly connected to the respective cylinders through the respective second exhaust valves.

10. A control apparatus for an internal combustion engine, comprising:
a plurality of cylinders each of which includes a first exhaust passage connected to a turbine of a turbocharger, a first exhaust valve that opens/closes the first exhaust passage, a second exhaust passage that leads to a position downstream of the turbine, and a second exhaust valve that opens/closes the second exhaust passage;
a first catalyst disposed in a third exhaust passage that is located downstream of a first join point at which the first exhaust passages are joined to the second exhaust passages;
catalyst warming-up means for warming up the first catalyst by closing the first exhaust valves, and opening the second exhaust valves, during a cold start of the internal combustion engine; and
first turbocharger drive means for dividing the cylinders into two cylinder groups, selecting one of the cylinder groups, and opening the first exhaust valves in the selected cylinder group to drive the turbocharger, when warming-up of the catalyst is completed.

11. The control apparatus according to claim 10, wherein:
the turbocharger and the first catalyst are provided for each of the cylinder groups;
the third exhaust passage is provided for each of the cylinder groups, and the third exhaust passages are joined together at a second join point downstream of the first catalysts; and
the control apparatus further includes a second catalyst that is disposed in a fourth exhaust passage downstream of the second join point at which the third exhaust passages are joined together, second-catalyst-temperature correlation value determination means for determining a second-catalyst-temperature correlation value that is correlated with a temperature of the second catalyst, and second turbocharger drive means for opening the first exhaust valves in the cylinder group that is not selected by the first turbocharger drive means, to drive the turbocharger for the cylinder group that is not selected by the first turbocharger drive means, when the second-catalyst-temperature correlation value is equal to or above a predetermined value.

12. The control apparatus according to claim 10, wherein:
the turbocharger and the first catalyst are provided for each of the cylinder groups; and
the first turbocharger drive, means opens the first exhaust valves in both of the cylinder groups to drive the turbochargers, when a required output of the internal combustion engine is equal to or above a predetermined value.

13. The control apparatus according to any one of claims 10 to 12, wherein
heat capacities of exhaust systems of the two cylinder groups are equal to each other; and
the first turbocharger drive means opens the first exhaust valves in one of the two cylinder groups, which is not selected by the first turbocharger drive means in an immediately preceding trip.

14. The control apparatus according to any one of claims 10 to 12, wherein
the first turbocharger drive means opens the first exhaust valves in one of the two cylinder groups, whose exhaust system has a smaller heat capacity than that of an exhaust system of the other of the two cylinder groups, when the internal combustion engine is started.

15. The control apparatus according to any one of claims 10 to 12, wherein
the first exhaust passages of one of the two cylinder groups is longer than the first exhaust passages of the other of the two cylinder groups; and
the first turbocharger drive means selects the one of the two cylinder groups.

16. A method of controlling an internal combustion engine, comprising:
opening a first exhaust valve that opens/closes a first exhaust passage connected to a turbine of a turbocharger, to drive the turbocharger;
determining a catalyst-temperature correlation value that is correlated with a temperature of a catalyst that is disposed in a third exhaust passage located downstream of a join point at which the first exhaust passage is joined to a second exhaust passage that leads to a position downstream of the turbine of the turbocharger, wherein a second exhaust valve opens/closes the second exhaust passage; and
retarding an ignition timing, if the catalyst-temperature correlation value is below a predetermined value when the first exhaust valve is opened.

17. A method of controlling an internal combustion engine that includes a plurality of cylinders each of which includes a first exhaust passage connected to a turbine of a turbocharger, a first exhaust valve that opens/closes the first exhaust passage, a second exhaust passage that leads to a position downstream of the turbine, and a second exhaust valve that opens/closes the second exhaust passage, the method comprising:
warming-up a first catalyst disposed in a third exhaust passage located downstream of a join point at which the first exhaust passages are joined to the second exhaust passages, by closing the first exhaust valves, and opening the second exhaust valves, during a cold start of the internal combustion engine; and
dividing the cylinders into two cylinder groups, selecting one of the cylinder groups, and opening the first exhaust valves in the selected cylinder group, to drive the turbocharger, when warming-up of the first catalyst is completed.
